(19) United States
(12) Patent Application Publication
(10) Pub. No.: US 2008/0287575 A1
(43) Pub. Date: Nov. 20, 2008

(54) Light-weight sculpturing compound without borax

(75) Inventors: Tak Kai Terry Lee, Tai Tam (HK); Huimin Wang, Kwai Chung (HK)

Correspondence Address: WOOD, PHILLIPS, KATZ, CLARK & MORTIMER, 500 W. MADISON STREET, SUITE 3800, CHICAGO, IL, 60661, US

(73) Assignee: Lai On Products (Industrial ), Ltd.

(21) Appl. No.: 11/803,784

(22) Filed: May 16, 2007

(51) Int. Cl. C08K 5/05; C08K 3/16; C08K 5/10

(52) U.S. Cl. 524/58; 524/317; 524/436

(57) ABSTRACT

A modeling composition is provided. The modeling composition is semi-water based as it includes both water and oil. In one embodiment, the modeling composition includes reverse osmosis water, polymer resin, oils, filler and calcium chloride. Additional components may also be included in the composition such as propylene glycol, sorbitol, pigments, preservatives and other components.

### FIELD OF THE INVENTION

This invention relates to modeling and sculpturing compounds, and in more particular applications, to sculpturing compounds without borax/borate for use by children.

### BACKGROUND OF THE INVENTION

The present invention is directed to lightweight sculpturing compounds, wherein the density is less than 1, which compounds are distinguishable from heavier compounds which have densities greater than 1.

The lightweight compounds typically include non-water-based compounds and water-based compounds. Non-water-based lightweight compounds include thermoplastic modeling compositions and wax/oil-based modeling compositions. The thermoplastic modeling compositions are generally used for producing design models in the automobile industry, such as described in U.S. Pat. No. 3,607,332. The modeling compositions are usually comprised of plastic, minerals, binders, light fillers, and color agents, which can be processed above 50° C. The shapes formed using these compositions become rigid and much harder as the ambient temperature drops. However, these compositions, as used in industrial applications, have no final aggregate state, cannot be kneaded and/or modeled at room temperature and are therefore not suitable as sculpturing compounds for children.

Alternatively, one wax/oil based lightweight modeling composition consists of solid wax, pasty wax, oil base and lightweight hollow microbead filler. Microbeads are monosized polymer particles which are mainly composed of two different classes of polymers, such as polystyrene and polyacrylics having varying degrees of cross linking. These compounds have lightweight behavior and can be kneaded and processed at room temperature. The resulting product is suitable for use by children.

Water-based compounds are normally air-dryable and incorporate starch as a filler. However, these compounds easily crack, flake, and crumble after drying because of poor plasticity, and substantial drying shrinkage. Even incorporating large proportions of filler in the compound mixture, there is still shrinkage due to volume reduction after drying. Additionally, water-based lightweight compounds combine water soluble resin such as poly vinyl alcohol (PVA) and lightweight fillers. Although they have an improved resistant to cracking, flaking, and crumbling, they can be initially sticky as well as having inferior strength, elasticity and moisture resistance. Furthermore, these compounds generally contain borax and/or borate based components which should not be used in compounds for children because of the toxicity of the borax and/or borate based components. For example, U.S. Pat. Nos. 5,171,766, 5,364,892, 5,506,280 and 6,359,057 disclose compositions containing borax/borate components, and therefore are not preferred for use by children.

### SUMMARY OF THE INVENTION

In one form, a modeling composition is provided. The modeling composition includes reverse osmosis water, polymer resin, oils, filler and calcium chloride.

According to one form, a modeling composition is provided. The modeling composition includes 30-70 wt. % reverse osmosis water, 5-30 wt. % polymer resin, 5-45 wt. % oil, 1-25 wt. % lightweight filler and 3-25 wt. % calcium chloride.

In one form, the oil includes 5-25 wt. % gelled mineral oils. According to one form, the oil further includes 0-20 wt. % mineral oils. In one form, the composition further includes 0-20 wt. % propylene glycol. According to one form, the composition further includes 0-20 wt. % sorbitol.

In one form, the composition further includes 0-10 wt. % propylene glycol and 0-10 wt. % sorbitol.

According to one form, the polymer resin is a water based polymer or copolymer.

In one form, the water based polymer or copolymer includes at least one of polyvinyl alcohol, water-based polyurethane, water-based acrylic polymer and copolyester.

According to one form, the lightweight fillers include at least one of encapsulated microspheres and microbeads.

In one form, the composition further includes 0.01-1.0 wt. % preservatives. According to one form, the preservatives are selected from the parabens series.

In one form, the preservatives include at least one of methylparaben, propylparaben, ethylparaben, and phenoxyethanol.

Other objects, advantages, and features will become apparent from a complete review of the entire specification, including the appended claims and drawings.

### DETAILED DESCRIPTION OF THE PREFERRED EMBODIMENTS

While the present invention is susceptible of embodiment in many different forms, as will be described herein in detail specific embodiments thereof with the understanding that the present disclosure is to be considered as an exemplification of the principles of the invention and is not intended to limit the invention to the specific embodiments illustrated.

In one form, a modeling composition for use by children includes reverse osmosis water, polymer resin, oils, filler and calcium chloride. Therefore, the modeling composition is semi-water based as it includes both water and oil. Additional components may also be included in the composition such as propylene glycol, sorbitol, pigments, preservatives and other components.

In a preferred embodiment, the polymer resin is poly vinyl alcohol (PVA) such as from the Celvol series having a pH value in the range of 5-7 in a 4 wt. % solution. In one form, the degree of hydrolysis is 88.00±2.00 mole %, and 4% solution viscosity, 5.70±1.50 cP. In one form, the bulk density is 0.6-0.7 grams per milliliter and the melting point range is 180-250° C. In a preferred form, the PVA is high molecular weight PVA. It should be understood by those skilled in the art that other polymer resins, as well as other forms of PVA may be utilized. For example, the polymer resin can include other water-soluble polymers such as water based polyurethane, water based polyethylene oxide, water based acrylic polymer or copolyester or other water-soluble polymers, as well as their mixtures.

A variety of oils may be used in the composition. For example, mineral oils, gelled mineral oils, moisturizing gels and combinations thereof may be used. In one form, the viscosities range from 10,000 to 200,000 cps at 25° C. while the specific gravity is 0.82±0.03 at 25° C.

In one embodiment, the lightweight filler includes encapsulated copolymers or microspheres. Encapsulated copolymers or microspheres, such as made under the name of Expancel®, manufactured by Akzo Nobel, are completely different materials from hollow microbeads, each with different microstructures and functions. For example, the microspheres have a polymer shell encapsulating a gas which is quite different from hollow microbeads used in other commercial clay products. When the gas inside the shell is heated, the internal pressure increases and the thermoplastic shell softens, resulting in a dramatic increase in the volume of the microspheres. When fully expanded, the volume of the microspheres can increases more than 40 times the original volume. Microbeads, however, are monosized polymer particles, which are mainly composed of two different classes of polymers like polystyrene and polyacrylics having varying degrees of cross linking. The polymer particles have a perfect spherical shape, are highly monosized and are made within a wide particle size range, such as 0.5-500 micron.

One suitable form of microspheres or encapsulated copolymers that can be used is EXPANCEL® DE (Akzo Nobel) products series products with density ranges of 20-70 KG/m³, such as EXPANCEL 051, EXPANCEL 091, EXPANCEL 461, EXPANCEL 551, etc. Additionally, other suitable forms include Phenoset® microspheres or Minoset® microspheres. Another example of suitable lightweight microspheres includes DUALITE® expanded spheres manufactured by Pierce and Stevens, which consist of a flexible, ultra-low density thermoplastic hollow microsphere core filled with a gas. Usually, this form of microsphere has its surface coated with calcium carbonate.

Additionally, lightweight fillers, such as cenospheres can be utilized. Cenospheres are small, lightweight, inert, hollow microspheres comprising largely of silica (such as synthetic precipitated silica) and alumina and are filled with low pressure gases.

Other lightweight fillers can also include expandable plastic powders, such as expandable thermoplastic powders and expandable thermosetting plastic powders. The expandable thermoplastic powders include expandable polystyrene powders, expandable polyethylene powders, expandable polypropylene powders and so on. The expandable thermosetting plastic powders mean expandable polyurethane plastic powders, etc.

Furthermore, the composition may contain additional components such as calcium chloride, propylene glycol, sorbitol and the like as understood by those skilled in the art.

Additionally, the composition may contain colorants or pigments including regular pigments, neon pigments, pearl pigments as well as mixtures thereof. For example, the regular pigments include Ultramarine Blue, FD&C Yellow 5 Aluminum Lake, FD&C Red 40 Aluminum Lake, FD&C Yellow 6 Aluminum Lake, FD&C Blue 1 Aluminum Lake, Titanium Dioxide, D&C red 7 Calcium Lake, TG-601 Gold, K-100 Black or their blends. The content range of the regular pigments is from 0.1 to 5% by weight. In one embodiment, the perfected range is 0.3 to 3% by weight.

The neon pigments include pigments such as Sterling Florescent Red 3, Sterling Florescent Blue 60, Sterling Florescent Yellow 27, Sterling Florescent Strong Magenta 21, Sterling Florescent Orange 5, Sterling Florescent Green 8 or their blends have a content range of 0.1 to 3% by weight, and the preferred range is 0.5 to 2% by weight. The pearl pigments include 5500 Timica silver sparkle, 1500 Timica extra bright, 110A Timica pearl white as well as their blends with regular or Neon pigments etc. The content range is from 5 to 20% by weight. The preferred range is 10 to 15% by weight.

Preservatives having pH values of 3 to 10 are suitable for the present composition. The preservatives as used in the following examples are taken paraben series such as propylparaben and methylparaben, ethylparaben, and phenoxyethanol

One form of the modeling composition, Example 1, is shown below in Table 1.

### EXAMPLE 1

TABLE 1

| | Percentage range | Perfected range |
|---|---|---|
| Ingredient | by weight % | by weight % |
| RO water | 30–70 | 50–65 |
| Polymer resin | 5–30 | 15–25 |
| Gelled Mineral Oils | 5–25 | 8–20 |
| Mineral Oils | 0–20 | 3–10 |
| Lightweight fillers | 1–25 | 2–20 |
| Calcium Chloride | 3–25 | 5–20 |
| Pigment | / | / |
| Preservative | 0.01–1.0 | 0.05–0.5 |

As shown in Table 1, the modeling compound includes reverse osmosis water (30-70 wt %), gelled mineral oils (5-25 wt %), mineral oils (0-20 wt %), polymer resin (5-30 wt %), light weight filler (1-25 wt %), calcium chloride (3-25 wt %), and preservatives (0.1-1.0 wt %). One form of the modeling composition includes reverse osmosis water (50-65 wt %), gelled mineral oils (8-20 wt %), mineral oils (3-10 wt %), polymer resin (15-25 wt %), light weight filler (3-20 wt %), calcium chloride (5-20 wt %), and preservatives (0.05-0.5 wt %).

Another example of the modeling composition is shown in Table 2 below.

### EXAMPLE 2

TABLE 2

| | Percentage range | Perfected range |
|---|---|---|
| Ingredient | by weight % | by weight % |
| RO water | 30–70 | 50–65 |
| Polymer resin | 5–30 | 15–25 |
| Gelled mineral oils | 5.0–25.0 | 8.0–20 |
| Light fillers | 1.0–25 | 3.0–20 |
| Calcium Chloride | 3.0–25 | 5.0–20 |
| Propylene glycol | 0–20 | 3.0–10 |
| Pigment | / | / |
| Preservative | 0.1–1.0 | 0.05–0.5 |

As shown in Table 2, the modeling composition includes reverse osmosis water (30-70 wt %), gelled mineral oils (5-25 wt %), propylene glycol (0-20 wt %), polymer resin (5-30 wt %), light weight filler (1-25 wt %), calcium chloride (3-25 wt %), and preservatives (0.1-1.0 wt %). In one form, the modeling composition includes reverse osmosis water (50-65 wt %), gelled mineral oils (8-20 wt %), propylene glycol (3-10 wt %), polymer resin (15-25 wt %), light weight filler (3-20 wt %), calcium chloride (5-20 wt %), and preservatives (0.05-0.5 wt %).

Yet another example of the modeling composition is shown in Table 3 below.

### EXAMPLE 3

TABLE 3

| | Percentage range | Perfected range |
|---|---|---|
| Ingredient | by weight % | by weight % |
| RO water | 30–70 | 50–65 |
| Polymer resin | 5–30 | 15–25 |
| Gelled mineral oils | 5.0–25.0 | 8.0–20 |
| Light fillers | 1.0–25 | 3.0–20 |
| Calcium Chloride | 3.0–25 | 5.0–20 |
| Sorbitol | 0–20 | 3.0–10 |
| Pigment | / | / |
| Preservative | 0.1–1.0 | 0.05–0.5 |

As shown in Table 3, the modeling composition includes reverse osmosis water (30-70 wt %), gelled mineral oils (5-25 wt %), sorbitol (0-20 wt %), polymer resin (5-30 wt %), light weight filler (1-25 wt %), calcium chloride (3-25 wt %), and preservatives (0.1-1.0 wt %). In one form, the modeling composition includes reverse osmosis water (50-65 wt %), gelled mineral oils (8-20 wt %), sorbitol (3-10 wt %), polymer resin (15-25 wt %), light weight filler (3-20 wt %), calcium chloride (5-20 wt %), and preservative (0.05-0.5 wt %).

A further example of the modeling composition is shown in Table 4 below.

TABLE 4

| | Percentage range | Perfected range |
|---|---|---|
| Ingredient | by weight % | by weight % |
| RO water | 30–70 | 50–65 |
| Polymer resin | 5–30 | 15–25 |
| Gelled mineral oils | 5.0–25.0 | 8.0–20 |
| Light fillers | 1.0–25 | 3.0–20 |
| Calcium Chloride | 3.0–25 | 5.0–20 |
| Propylene glycol | 0–10 | 3.0–6.0 |
| Sorbitol | 0–10 | 3.0–6.0 |
| Pigment | / | / |
| Preservative | 0.1–1.0 | 0.05–0.5 |

As shown in Table 4, the modeling composition includes reverse osmosis water (30-70 wt %), gelled mineral oils (5-25 wt %), propylene glycol (0-10 wt %), sorbitol (0-10 wt %), polymer resin (5-30 wt %), light weight filler (1-25 wt %), calcium chloride (3-25 wt %), and preservatives (0.1-1.0 wt %). In one form, the modeling composition includes reverse osmosis water (50-65 wt %), gelled mineral oils (8-20 wt %), propylene glycol (3-6 wt %), sorbitol (3-6 wt %), polymer resin (15-25 wt %), light weight filler (3-20 wt %), calcium chloride (5-20 wt %), and preservatives (0.05-0.5 wt %).

A further example of the modeling composition is shown in Table 5 below.

TABLE 5

| | Percentage range | Perfected range |
|---|---|---|
| Ingredient | by weight % | by weight % |
| RO water | 30–70 | 50–65 |
| Polymer resin | 5–30 | 15–25 |
| Gelled mineral oils | 5.0–25.0 | 8.0–20 |
| Mineral oils | 0–20 | 3.0–10 |
| Light fillers | 1.0–25 | 3.0–20 |
| Calcium Chloride | 3.0–25 | 5.0–20 |
| Propylene glycol | 0–10 | 3.0–6.0 |
| Sorbitol | 0–10 | 3.0–6.0 |
| Pigment | / | / |
| Preservative | 0.1–1.0 | 0.05–0.5 |

As shown in Table 5, the modeling composition includes reverse osmosis water (30-70 wt %), gelled mineral oils (5-25 wt %), mineral oils (0-20 wt %), polymer resin (5-30 wt %), light weight filler (1-25 wt %), calcium chloride (3-25 wt %), propylene glycol (0-10 wt %), sorbitol (0-10 wt %), and preservatives (0.1-1.0 wt %). In one form, the modeling composition includes reverse osmosis water (50-65 wt %), gelled mineral oils (8-20 wt %), mineral oils (3-10 wt %), polymer resin (15-25 wt %), light weight filler (3-20 wt %), calcium chloride (5-20 wt %), propylene glycol (3-6 wt %), sorbitol (3-6 wt %), and preservatives (0.05-0.5 wt %).

One embodiment of a method of manufacturing the modeling composition is outlined below. High molecular weight PVA is placed in a vessel with water and stirred at medium speed for 10-30 minutes to disperse the PVA. The mixture is heated to 70-90° C. under continual stirring for 1-2 hours until the PVA is completely dissolved. The mixture is then cooled. The cooled mixture is next placed in a mixer and the remaining ingredients can be added. These ingredients may include and, in one form, are added in the following order: sorbitol, propylene glycol, colorants, oil and gelled oil such as gelled mineral oil, preservatives, calcium chloride and finally any microspheres and the like. The resulting mixture should be stirred at low speed for 20-50 minutes until the composition is uniform.

In one form, the modeling composition has excellent resistance to freezing and can withstand −20° C. for at least 72 hours and withstand a thermal cycling test from −10 to 40° C. for at least seven days. Furthermore, in one form, the modeling composition is capable of withstanding an aging test at 60° C. for at least ten days.

While the invention has been described herein with regards to specific examples and embodiments, it should be understood by those skilled in the art that other examples and embodiments are also contemplated.

We claim:

1. A modeling composition comprising reverse osmosis water, polymer resin, oils, filler and calcium chloride.

2. The modeling composition of claim 1 wherein the polymer resin is a water based polymer or copolymer.

3. The modeling composition of claim 2 wherein the water based polymer or copolymer includes at least one of polyvinyl alcohol, water-based polyurethane, water-based acrylic polymer and copolyester.

4. The modeling composition of claim 1 further comprising propylene glycol.

5. The modeling composition of claim 1 further comprising sorbitol.

6. The modeling composition of claim 1 further comprising propylene glycol and sorbitol.

7. The modeling composition of claim 1 wherein the lightweight fillers include at least one of encapsulated microspheres and microbeads.

8. The modeling composition of claim 1 further comprising pigments and preservatives.

9. The modeling composition of claim 8 wherein the preservatives are selected from the parabens series.

10. The modeling composition of claim 9 wherein the preservatives include at least one of methylparaben, propylparaben, ethylparaben, and phenoxyethanol.

11. A modeling composition comprising:
30-70 wt. % reverse osmosis water;
5-30 wt. % polymer resin;
5-45 wt. % oil;
1-25 wt. % lightweight filler; and
3-25 wt. % calcium chloride.

12. The modeling composition of claim 11 wherein the oil includes 5-25 wt. % gelled mineral oils.

13. The modeling composition of claim 11 wherein the oil further includes 0-20 wt. % mineral oils.

14. The modeling composition of claim 11 further comprising 0-20 wt. % propylene glycol.

15. The modeling composition of claim 11 further comprising 0-20 wt. % sorbitol.

16. The modeling composition of claim 11 further comprising 0-10 wt. % propylene glycol and 0-10 wt. % sorbitol.

17. The modeling composition of claim 11 wherein the polymer resin is a water based polymer or copolymer.

18. The modeling composition of claim 17 wherein the water based polymer or copolymer includes at least one of polyvinyl alcohol, water-based polyurethane, water-based acrylic polymer and copolyester.

19. The modeling composition of claim 1 wherein the lightweight fillers include at least one of encapsulated microspheres and microbeads.

20. The modeling composition of claim 1 further comprising 0.01-1.0 wt. % preservatives.

21. The modeling composition of claim 8 wherein the preservatives are selected from the parabens series.

22. The modeling composition of claim 9 wherein the preservatives include at least one of methylparaben, propylparaben, ethylparaben, and phenoxyethanol.
